(19) United States
(12) Patent Application Publication
(10) Pub. No.: US 2020/0301954 A1
(43) Pub. Date: Sep. 24, 2020

(54) REPLY INFORMATION OBTAINING METHOD AND APPARATUS

(71) Applicant: Tencent Technology (Shenzhen) Company Limited, Shenzhen (CN)

(72) Inventors: Yang CHAO, Shenzhen (CN); Yao LV, Shenzhen (CN); Dong LI, Shenzhen (CN); Guangyuan SUN, Shenzhen (CN); Ran WEI, Shenzhen (CN); Tao ZHENG, Shenzhen (CN)

(21) Appl. No.: 16/895,992

(22) Filed: Jun. 8, 2020

Related U.S. Application Data
(63) Continuation of application No. PCT/CN2019/074185, filed on Jan. 31, 2019.

(30) Foreign Application Priority Data
Mar. 15, 2018 (CN) 201810215381,3

(51) Int. Cl. G06F 16/33; G06F 16/332; G06F 16/31

(52) U.S. Cl. CPC G06F 16/3338; G06F 16/3329; G06F 16/3334; G06F 16/313; G06F 16/328; G06F 16/3344

(57) ABSTRACT

This application discloses a reply information obtaining method and apparatus. The method includes: determining a target keyword corresponding to target question information according to the target question information obtained by a client; determining, according to the target keyword, a target information topic to which the target question information belongs in a plurality of information topics; and obtaining target reply information corresponding to the target question information from a target information group in a plurality of information groups, the target information group including a plurality of pairs of question information and reply information that correspond to each other, and the question information included in the target information group belonging to the target information topic. This application resolves a technical problem of relatively low efficiency of obtaining the reply information in the related art.

### CROSS-REFERENCE TO RELATED APPLICATIONS

This application is a continuation application of PCT Patent Application No. PCT/CN2019/074185, entitled “REPLY INFORMATION OBTAINING METHOD AND APPARATUS” filed on Jan. 31, 2019, which claims priority to Chinese Patent Application No. 201810215381.3, entitled “REPLY INFORMATION OBTAINING METHOD AND APPARATUS” and filed with the National Intellectual Property Administration, PRC on Mar. 15, 2018, all of which are incorporated herein by reference in their entirety.

### FIELD OF THE TECHNOLOGY

This application relates to the field of computers, and in particular, to a reply information obtaining method and apparatus.

### BACKGROUND OF THE DISCLOSURE

An artificial intelligence markup language (AIML) adopted in conventional nature language understand (NLU) mainly relies on a large quantity of QA-pairs templates, and a large quantity of QA-pairs templates often need to be queried during retrieval of an answer to a question inputted by a user, which is inefficient and has limited functions.

For the foregoing problems, no effective solution has been proposed yet.

### SUMMARY

Embodiments of this application provide a reply information obtaining method and apparatus, to resolve at least a technical problem of low efficiency of obtaining reply information in the related art.

According to an aspect of the embodiments of this application, a method of obtaining reply information performed by a computing device having one or more processors and memory storing a plurality of programs to be executed by the one or more processors, the method comprising: determining a target keyword corresponding to target question information according to the target question information obtained by a client; determining, according to the target keyword, a target information topic to which the target question information belongs in a plurality of information topics; and obtaining target reply information corresponding to the target question information from a target information group in a plurality of information groups, the target information group including a plurality of pairs of question information and reply information that correspond to each other, and the question information in the target information group belonging to the target information topic.

According to another aspect of the embodiments of this application, a reply information obtaining apparatus is further provided. The apparatus includes: a first determining module, configured to determine a target keyword corresponding to target question information according to the target question information obtained by a client; a second determining module, configured to determine, according to the target keyword, a target information topic to which the target question information belongs in a plurality of information topics; and a first obtaining module, configured to obtain target reply information corresponding to the target question information from a target information group in a plurality of information groups, the target information group including a plurality of pairs of question information and reply information that correspond to each other, and the question information included in the target information group belonging to the target information topic.

According to another aspect of the embodiments of this application, a non-transitory computer readable storage medium is further provided, where the storage medium stores a computer program, the computer program being configured to perform the method described above when being run.

According to another aspect of the embodiments of this application, a computing device is further provided, including a memory and a processor, the memory storing a computer program, and the processor being configured to perform the method described above through the computer program.

In the embodiments of this application, a target keyword corresponding to target question information is determined according to the target question information obtained by a client; a target information topic to which the target question information belongs is determined in a plurality of information topics according to the target keyword; target reply information corresponding to the target question information is obtained from a target information group in a plurality of information groups, the target information group including a plurality of pairs of question information and reply information that correspond to each other, and the question information included in the target information group belonging to the target information topic. In this way, the question information and the reply information that correspond to each other are classified into a plurality of information groups according to information topics of the question information. When target reply information corresponding to target question information is to be obtained, a target information topic to which the target question information belongs is first determined, and then the target reply information corresponding to the target question information is obtained from a target information group corresponding to the target information topic, so that a question intention of the target question information can be positioned accurately. The target question information is positioned to the target information topic corresponding to the same intention, and the target reply information is obtained from the target information group corresponding to the target information topic, thereby avoiding querying a large quantity of QA-pairs templates, improving the efficiency of obtaining the reply information, and further resolving the technical problem of relatively low efficiency of obtaining the reply information in the related art.

### BRIEF DESCRIPTION OF THE DRAWINGS

The accompanying drawings described herein are used for providing further understanding for this application, and constitute a part of this application. Exemplary embodiments of this application and descriptions thereof are used for explaining this application and do not constitute an improper limitation to this application. In the accompanying drawings:

FIG. 1 is a schematic diagram of an optional reply information obtaining method according to an embodiment of this application.

FIG. 2 is a first schematic diagram of an application environment of an optional reply information obtaining method according to an embodiment of this application.

FIG. 3 is a second schematic diagram of an application environment of an optional reply information obtaining method according to an embodiment of this application.

FIG. 4 is a schematic diagram of an optional reply information obtaining method according to an optional implementation of this application.

FIG. 5 is a schematic diagram of another optional reply information obtaining method according to an optional implementation of this application.

FIG. 6 is a schematic diagram of an optional reply information obtaining apparatus according to an embodiment of this application.

FIG. 7 is a first schematic diagram of an application scenario of an optional reply information obtaining method according to an embodiment of this application.

FIG. 8 is a second schematic diagram of an application scenario of an optional reply information obtaining method according to an embodiment of this application.

FIG. 9 is a schematic diagram of an optional electronic apparatus according to an embodiment of this application.

### DESCRIPTION OF EMBODIMENTS

To make a person skilled in the art better understand solutions of this application, the following clearly and completely describes the technical solutions in embodiments of this application with reference to the accompanying drawings in the embodiments of this application. Apparently, the described embodiments are merely some rather than all of the embodiments of this application. All other embodiments obtained by a person skilled in the art based on the embodiments of this application without creative efforts shall fall within the protection scope of this application.

In the specification, claims, and accompanying drawings of this application, the terms “first”, “second”, and so on are intended to distinguish between similar objects rather than indicating a specific order. It is to be understood that the data termed in such a way are interchangeable in proper circumstances, so that the embodiments of this application described herein can be implemented in orders except the order illustrated or described herein. In addition, the terms “include”, “comprise” and any other variants are intended to cover the non-exclusive inclusion. For example, a process, method, system, product, or device that includes a series of steps or units is not necessarily limited to those expressly listed steps or units, but may include other steps or units not expressly listed or inherent to such a process, method, product, or device.

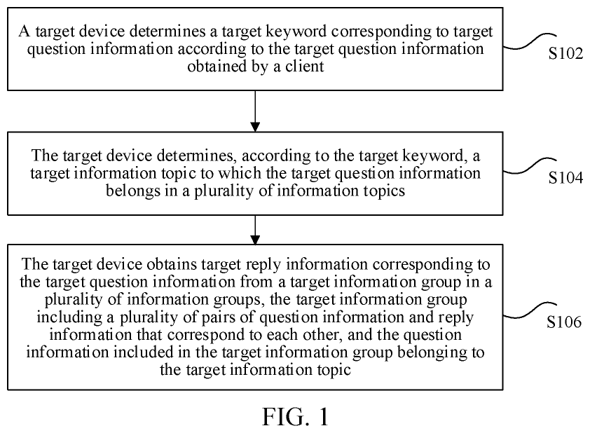

According to an aspect of the embodiments of this application, a reply information obtaining method is performed by a target device (e.g., a computer server having one or more processors and memory storing a plurality of programs to be executed by the one or more processors). As shown in FIG. 1, the method includes:

S102. A target device determines a target keyword corresponding to target question information according to the target question information obtained by a client.

S104. The target device determines, according to the target keyword, a target information topic to which the target question information belongs in a plurality of information topics.

S106. The target device obtains target reply information corresponding to the target question information from a target information group in a plurality of information groups, the target information group including a plurality of pairs of question information and reply information that correspond to each other, and the question information included in the target information group belonging to the target information topic.

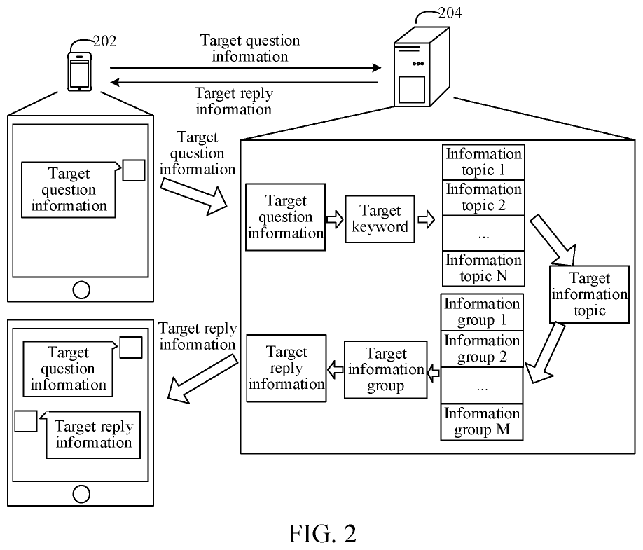

Optionally, in this embodiment, the foregoing reply information obtaining method may be applied to a hardware environment composed of a client 202 and a server 204 as shown in FIG. 2. As shown in FIG. 2, the client 202 obtains target question information inputted by a user, displays the target question information on a display interface, and transmits the target question information to the server 204. The server 204 determines a target keyword corresponding to the target question information according to the target question information; determines, according to the target keyword, a target information topic to which the target question information belongs in a plurality of information topics (information topics 1 to N); and obtains target reply information corresponding to the target question information from a target information group in a plurality of information groups (information groups 1 to M), the target information group including a plurality of pairs of question information and reply information that correspond to each other, and the question information included in the target information group belonging to the target information topic. The server 204 returns the obtained target reply information to the client 202. The client 202 displays the target reply information returned by the server 204 on the display interface.

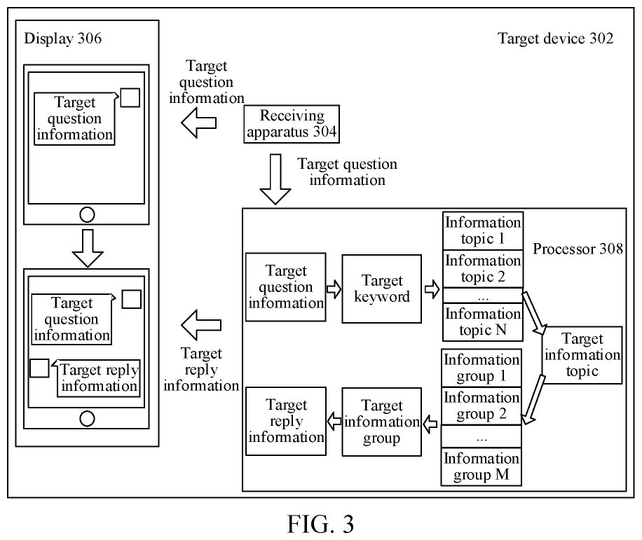

Optionally, in this embodiment, the foregoing reply information obtaining method may be applied to a hardware environment composed of a target device 302 as shown in FIG. 3. As shown in FIG. 3, a receiving apparatus 304, a display 306, and a processor 308 are configured on the target device 302. The receiving apparatus 304 obtains target question information inputted by a user, displays the target question information on the display 306, and transmits the target question information to the processor 308. The processor 308 determines a target keyword corresponding to target question information according to the target question information; determines, according to the target keyword, a target information topic to which the target question information belongs in a plurality of information topics; and obtains target reply information corresponding to the target question information from a target information group in a plurality of information groups, the target information group including a plurality of pairs of question information and reply information that correspond to each other, and the question information included in the target information group belonging to the target information topic. The processor 308 transmits the obtained target reply information to the display 306. The display 306 displays the target reply information on a screen.

Optionally, in this embodiment, the foregoing target device may be, but is not limited to, a client, a server, and the like.

Optionally, in this embodiment, the foregoing reply information obtaining method may be applied to, but is not limited to, a scenario of obtaining reply information corresponding to question information. The foregoing client may be, but is not limited to, various applications, for example, an on-line education application, an instant messaging application, a community space application, a game application, a shopping application, a browser application, a financial application, a multimedia application, and a live broadcast application. Optionally, the reply information obtaining method may be applied to, but is not limited to, a scenario of obtaining reply information corresponding to question information in the foregoing game application, or may be applied to, but is not limited to, a scenario of obtaining reply information corresponding to question information in the foregoing shopping application, so as to improve the efficiency of obtaining reply information. The foregoing description is merely an example, which is not limited in this embodiment.

Optionally, in this embodiment, the target question information may be in the following forms: text information, voice information, and the like, but is not limited thereto. For example, in a case that the target question information is in a form of voice information, a voice of the target question information may be converted into text information first, then a target keyword corresponding to the target question information is determined according to the text information, so as to determine a target information topic according to the target keyword, and target reply information is then obtained from a target information group corresponding to the target information topic.

Optionally, in this embodiment, the target keyword corresponding to the target question information may be but is not limited to a keyword extracted from the target question information, and may further include a keyword generated according to the extracted keyword, or may further include information used for representing a hyponymy relationship between the extracted keywords. For example, the keywords extracted from the target question information include a keyword A and a keyword B. It is also obtained that the keyword A is a hypernym keyword of the keyword B; in addition, the keyword A is a hypernym keyword of a keyword C, the keyword C is a hypernym keyword of the keyword B. In this case, the target keyword may include the keyword A, the keyword B, and that the keyword A is the hypernym keyword of the keyword B, or the target keyword may include the keyword A, the keyword B, and the keyword C.

Optionally, in this embodiment, the hyponymy relationship between the keywords may be used for representing a subordinate relationship between fields to which the keywords belong, but is not limited thereto. That a keyword 1 is the hypernym keyword of a keyword 2 may be, but is not limited to, that a field to which the keyword 2 belongs is a sub-field of a field to which the keyword 1 belongs. For example, among a feline animal, a tiger, and a Siberian tiger, a field to which the tiger belongs is a sub-field of a field to which the feline animal belongs, and a field to which the Siberian tiger belongs is a sub-field of a field to which the tiger belongs.

Optionally, in this embodiment, a plurality of information topics may be used for representing fields of the keywords (for example, weather, geography, and history), or may represent functions required to be implemented by intentions conveyed by the question information. For example, if an intention conveyed by the question information is to contact customer service staff to obtain a post-sales service, an information topic to which the question information belongs may be customer service. By means of this manner, the question information can be positioned to a corresponding field according to the question information, and moreover, an intention expressed by the question information can be identified precisely, so as to provide a variety of functional services for the user.

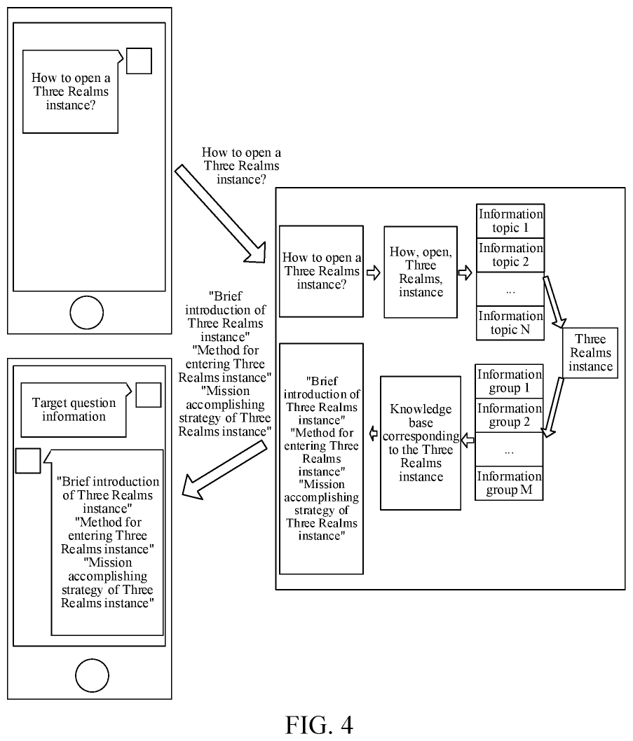

In an optional implementation, using a QA system in a game client as an example, as shown in FIG. 4, when target question information “how to open a Three Realms instance?” inputted by a player is received, filter processing is performed on the target question information to remove unimportant words such as punctuations, function words, and adverbs, to obtain a complete word sequence “how, open, Three Realms, instance”. Then, a phrase “Three Realms instance” with highest relevance to these words is obtained and queried according to hyponymy relationships between words, and these words are inputted into an interpreter of the AIML. Finally, it is determined that an intention of the player is to obtain a method for opening a Three Realms instance. The foregoing target question information is positioned to an information topic of the “Three Realms instance”, and corresponding reply information is retrieved from a knowledge base corresponding to the Three Realms instance. Information of the obtained target reply information such as “brief introduction of Three Realms instance”, “method for entering Three Realms instance”, and “mission accomplishing strategy of Three Realms instance” are displayed on the display interface of the client.

Obviously, through the foregoing steps, question information and reply information that correspond to each other are classified into a plurality of information groups according to information topics of the question information. When target reply information corresponding to target question information is to be obtained, a target information topic to which the target question information belongs is first determined, and then the target reply information corresponding to the target question information is obtained from a target information group corresponding to the target information topic, so that a question intention of the target question information can be positioned accurately. The target question information is positioned to the target information topic corresponding to the same intention, and the target reply information is obtained from the target information group corresponding to the target information topic, thereby avoiding querying a large quantity of QA-pairs templates, improving the efficiency of obtaining the reply information, and further resolving the technical problem of relatively low efficiency of obtaining the reply information in the related art.

In an optional solution, that the target device determines, according to the target keyword, a target information topic to which the target question information belongs in a plurality of information topics includes:

S1. The target device looks up an information topic to which each keyword in the target keyword belongs from the plurality of information topics.

S2. The target device determines the information topic to which each keyword in the target keyword belongs as the target information topic to which the target question information belongs.

Optionally, in this embodiment, the information topic corresponding to each keyword in the target keyword may be determined as the target information topic corresponding to the target question information, thereby positioning an intention expressed by the target question information.

Optionally, in this embodiment, the information topics to which the keywords in the target keyword belong may have certain relationships. In this case, the information topics to which the keywords in the target keyword belong may be combined according to these relationships. For example, if information topics to which two words belong are in a hyponymy relationship, an information topic to which a hypernym word belongs is removed through filtering, and only an information topic to which a hyponym word belongs is used as the target information topic. Alternatively, the information topic to which the hyponym word belongs may be removed through filtering, and only the information topic to which the hypernym word belongs is used as the target information topic. In this way, a range for positioning the target question information is controlled.

In an optional solution, that the target device obtains target reply information corresponding to the target question information from a target information group in a plurality of information groups includes:

S1. The target device obtains a target tag corresponding to the target information topic, the target tag being used for identifying the target information topic.

S2. The target device obtains the target information group corresponding to the target tag from tags and information groups that correspond to each other.

S3. The target device looks up reply information corresponding to the target question information from each information group of the target information group respectively.

S4. The target device combines the reply information corresponding to the target question information in each information group into the target reply information.

Optionally, in this embodiment, corresponding tags may be allocated to the information topics to identify the information topics, and a correspondence between the tags and the information groups may be created. After the target information topic of the target question information is determined, the target information group may be obtained according to the tag corresponding to the target information topic.

Optionally, in this embodiment, the target information group may be one or more information groups. If there are a plurality of target information groups, each piece of reply information corresponding to the target question information may be obtained from each target information group, and then the pieces of reply information are combined into the target reply information.

In an optional solution, the determining a target keyword corresponding to target question information according to the target question information obtained by a client includes:

S1. The target device extracts a first keyword from the target question information to obtain a word sequence including the first keyword.

S2. The target device obtains a relationship sequence corresponding to the word sequence from a graph master, the graph master using the plurality of information topics as nodes, the graph master being used for recording hyponymy relationships between the nodes, and the relationship sequence being used for indicating a hyponymy relationship between the first keywords.

S3. The target device determines that the target keyword includes the word sequence and the relationship sequence.

Optionally, in this embodiment, the process of extracting the first keyword from the target question information may include a pre-processing process, a word segmentation process, a keyword determining process, and a word sequence generating process. The target question information is pre-processed and cleaned in the pre-processing process, so that redundancy information such as symbols and stop words is removed. The target question information is divided into words with different granularities in the word segmentation process. An appropriate word is extracted from the words with different granularities as the first keyword in the keyword determining process. In the word sequence generating process, the word sequence is generated by using the determined first keyword. For example, after a user inputs a sentence, a data pre-processing and cleaning process is performed on the sentence to remove special symbols and stop words, and a word sequence is obtained by using a probabilistic annotation model of hidden Markov model (HMM)+conditional random field (CRF).

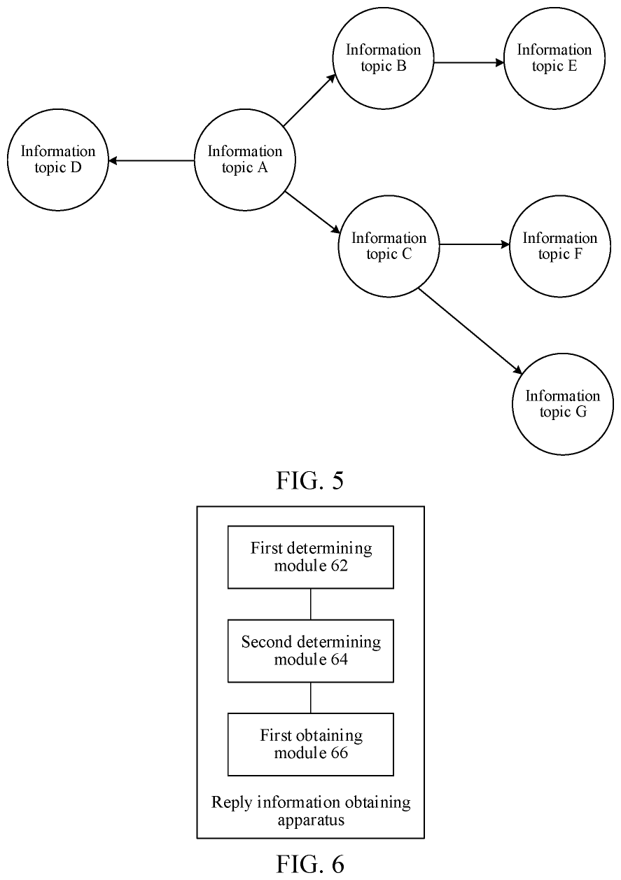

Optionally, in this embodiment, the hyponymy relationships between the plurality of information topics may be recorded by using a graph master. For example, as shown in FIG. 5, the graph master uses a plurality of information topics (an information topic A, an information topic B, an information topic C, an information topic D, an information topic E, an information topic F, and an information topic G) as nodes, and uses connection relationships between the nodes to represent hyponymy relationships between the information topics. For example, two associated information topics are connected by using an arrow, where an information topic at a start point of the arrow is a hypernym information topic of an information topic at an end of the arrow, and the information topic at the end of the arrow is a hyponym information topic of the information topic at the start point of the arrow. Hyponym information topics of the information topic A include the information topic B, the information topic C, and the information topic D; a hyponym information topic of the information topic B includes the information topic E; and hyponym information topics of the information topic C include the information topic F and the information topic G.

Optionally, in this embodiment, the tag used for identifying the information topic may be, but is not limited to, a tag in the AIML, and there is a correspondence between tags and information topics. After obtaining a first information topic to which a word sequence belongs and a second information topic to which a relationship sequence belongs, a first tag corresponding to the first information topic and a second tag corresponding to the second information topic may be obtained, and an intention expressed by target question information is precisely indicated by using the first tag and the second tag. The first tag and the second tag are added to an AIML file, and the AIML file is executed to invoke a first information group corresponding to the first tag to obtain first reply information, and invoke a second information group corresponding to the second tag to obtain second reply information. The first reply information and the second reply information are combined to obtain the target reply information.

For example, a first information topic to which a word sequence belongs in a plurality of information topics is obtained, and a second information topic to which a relationship sequence belongs in the plurality of information topics is obtained. A first tag corresponding to the first information topic is obtained, and a second tag corresponding to the second information topic is obtained. An AIML file carrying the first tag and the second tag is generated. The AIML file is executed to look up a first information group corresponding to the first tag for first reply information corresponding to the target question information, and to look up a second information group corresponding to the second tag for second reply information corresponding to the target question information. The first reply information and the second reply information are combined to obtain the target reply information.

Optionally, in this embodiment, the tag may be used for, but is not limited to, representing functions that can be implemented by the AIML file, for example, weather, database, joke, idiom, customer service, context, time, recursion, memory, knowledge, and other functions. For example, the weather function may be used for querying the weather, the customer service function may be used for connecting to a customer service system, and the context function may be used for analyzing a context. Other functions are similar to this, and details are not described herein again.

The foregoing functions that can be implemented by the tags in this embodiment are merely an example, other functions (for example, history, food, movie information, music, film, entertainment, game, and the like) may further be configured, which are not limited in this embodiment herein.

In an optional solution, in a case that the target device does not obtain the target reply information corresponding to the target question information from the target information group in the plurality of information groups, the method further includes:

S1. The target device inputs the target question information into a predetermined information group.

S2. The target device obtains a plurality of pieces of reply information corresponding to the target question information outputted by the predetermined information group.

S3. The target device obtains reply information satisfying a target condition from the plurality of pieces of reply information, and determines the reply information satisfying the target condition as the target reply information.

Optionally, in this embodiment, if the target reply information is not hit in the target information group, the target reply information may be obtained through a deep learning model in the predetermined information group.

Optionally, in this embodiment, a plurality of pieces of reply information corresponding to the target question information may be obtained through the deep learning model, and reply information satisfying the target condition is found in the plurality of pieces of reply information to serve as the target reply information.

In an optional solution, that the target device obtains reply information satisfying the target condition in the plurality of pieces of reply information includes:

S1. The target device obtains relevance between each piece of reply information in the plurality of pieces of reply information and the target question information.

S2. The target device determines a target quantity of pieces of corresponding reply information with highest relevance in the plurality of pieces of reply information as the reply information satisfying the target condition.

Optionally, in this embodiment, the plurality of pieces of reply information may be sorted according to relevance between each piece of reply information and the target question information, and several pieces of reply information with the highest relevance are used as the reply information satisfying the target condition.

Optionally, in this embodiment, a learning and updating function may further be implemented. For example, reply information selected by a user from a plurality of pieces of information satisfying the condition may be detected, and a correspondence between target question information and the reply information is created and recorded in a target information group corresponding to a target information topic to which the target question information belongs. Therefore, the reply information is used as target reply information when question information similar to the target question information is obtained next time.

In an optional solution, after the target device obtains the target reply information corresponding to the target question information from the target information group in a plurality of information groups, the method further includes:

S1. The target device transmits the target reply information to a client to instruct the client to display the target reply information on a display interface of the client; or

S2. The target device displays the target reply information on the display interface of the client.

Optionally, in this embodiment, the foregoing reply information obtaining method may be performed by a server, or may be performed by a client. After the target reply information is obtained, the target reply information may be displayed on the client. If the target reply information is obtained by the server, the server may transmit the target reply information to the client, to instruct the client to display the target reply information on the display interface of the client, and the target reply information is displayed on the display interface by the client. If the target reply information is obtained by the client, the client may display the obtained target reply information on the display interface.

Optionally, in this embodiment, the foregoing reply information obtaining method may be performed by the client and the server interactively. For example, the client obtains target question information, and determines a target keyword corresponding to the target question information according to the obtained target question information. The client transmits the target keyword to the server. The server determines, according to the target keyword, a target information topic to which the target question information belongs in a plurality of information topics, and obtains target reply information corresponding to the target question information from a target information group in a plurality of information groups. The server returns the target reply information to the client, and the client displays the target reply information on the display interface.

For brief description, the foregoing method embodiments are represented as a series of action combinations. However, a person skilled in the art shall appreciate that this application is not limited to the described order of the actions, because according to this application, some steps may be performed in other orders or simultaneously. In addition, it is to be understood by a person skilled in the art that the embodiments described in the specification all belong to exemplary embodiments and the actions and modules are not necessary for this application.

Through the description of the foregoing implementations, a person skilled in the art may clearly understand that the method according to the foregoing embodiments may be implemented by means of software and a necessary general hardware platform, and may also be implemented by hardware, but in many cases, the former manner is a better implementation. Based on such an understanding, the technical solutions of this application essentially or the part contributing to the related art may be implemented in a form of a software product. The computer software product is stored in a storage medium (such as a ROM/RAM, a magnetic disk, or an optical disc) and includes several instructions for instructing a terminal device (which may be a mobile phone, a computer, a server, a network device, or the like) to perform the methods described in the embodiments of this application.

According to another aspect of the embodiments of this application, a reply information obtaining apparatus configured to implement the foregoing reply information obtaining method is further provided. As shown in FIG. 6, the apparatus includes:

(1) a first determining module 62, configured to determine a target keyword corresponding to target question information according to the target question information obtained by a client;

(2) a second determining module 64, configured to determine, according to the target keyword, a target information topic to which the target question information belongs in a plurality of information topics; and

(3) a first obtaining module 66, configured to obtain target reply information corresponding to the target question information from a target information group in a plurality of information groups, the target information group including a plurality of pairs of question information and reply information that correspond to each other, and the question information included in the target information group belonging to the target information topic.

Optionally, in this embodiment, the foregoing reply information obtaining method may be applied to a hardware environment composed of a client 202 and a server 204 as shown in FIG. 2. As shown in FIG. 2, the client 202 obtains target question information inputted by a user, displays the target question information on a display interface, and transmits the target question information to the server 204. The server 204 determines a target keyword corresponding to the target question information according to the target question information; determines, according to the target keyword, a target information topic to which the target question information belongs in a plurality of information topics; and obtains target reply information corresponding to the target question information from a target information group in a plurality of information groups, the target information group including a plurality of pairs of question information and reply information that correspond to each other, and the question information included in the target information group belonging to the target information topic. The server 204 returns the obtained target reply information to the client 202. The client 202 displays the target reply information returned by the server 204 on the display interface.

Optionally, in this embodiment, the foregoing reply information obtaining apparatus may be applied to a hardware environment composed of a target device 302 as shown in FIG. 3. As shown in FIG. 3, a receiving apparatus 304, a display 306, and a processor 308 are configured on the target device 302. The receiving apparatus 304 obtains target question information inputted by a user, displays the target question information on the display 306, and transmits the target question information to the processor 308. The processor 308 determines a target keyword corresponding to target question information according to the target question information; determines, according to the target keyword, a target information topic to which the target question information belongs in a plurality of information topics; and obtains target reply information corresponding to the target question information from a target information group in a plurality of information groups, the target information group including a plurality of pairs of question information and reply information that correspond to each other, and the question information included in the target information group belonging to the target information topic. The processor 308 transmits the obtained target reply information to the display 306. The display 306 displays the target reply information on a screen.

Optionally, in this embodiment, the foregoing reply information obtaining apparatus may be applied to, but is not limited to, a scenario of obtaining reply information corresponding to question information. The foregoing client may be, but is not limited to, various applications, for example, an on-line education application, an instant messaging application, a community space application, a game application, a shopping application, a browser application, a financial application, a multimedia application, and a live broadcast application. Optionally, the reply information obtaining method may be applied to, but is not limited to, a scenario of obtaining reply information corresponding to question information in the foregoing game application, or may be applied to, but is not limited to, a scenario of obtaining reply information corresponding to question information in the foregoing shopping application, so as to improve the efficiency of obtaining reply information. The foregoing description is merely an example, which is not limited in this embodiment.

Optionally, in this embodiment, the target question information may be in the following forms: text information, voice information, and the like, but is not limited thereto. For example, in a case that the target question information is in a form of voice information, a voice of the target question information may be converted into text information first, then a target keyword corresponding to the target question information is determined according to the text information, so as to determine a target information topic according to the target keyword, and target reply information is then obtained from a target information group corresponding to the target information topic.

Optionally, in this embodiment, the target keyword corresponding to the target question information may be but is not limited to a keyword extracted from the target question information, and may further include a keyword generated according to the extracted keyword, or may further include information used for representing a hyponymy relationship between the extracted keywords. For example, the keywords extracted from the target question information include a keyword A and a keyword B. It is also obtained that the keyword A is a hypernym keyword of the keyword B; in addition, the keyword A is a hypernym keyword of a keyword C, the keyword C is a hypernym keyword of the keyword B. In this case, the target keyword may include the keyword A, the keyword B, and that the keyword A is the hypernym keyword of the keyword B, or the target keyword may include the keyword A, the keyword B, and the keyword C.

Optionally, in this embodiment, the hyponymy relationship between the keywords may be used for representing a subordinate relationship between fields to which the keywords belong, but is not limited thereto. That a keyword 1 is the hypernym keyword of a keyword 2 may be, but is not limited to, that a field to which the keyword 2 belongs is a sub-field of a field to which the keyword 1 belongs. For example, among a feline animal, a tiger, and a Siberian tiger, a field to which the tiger belongs is a sub-field of a field to which the feline animal belongs, and a field to which the Siberian tiger belongs is a sub-field of a field to which the tiger belongs.

Optionally, in this embodiment, a plurality of information topics may be used for representing fields of the keywords (for example, weather, geography, and history), or may represent functions required to be implemented by intentions conveyed by the question information. For example, if an intention conveyed by the question information is to contact customer service staff to obtain a post-sales service, an information topic to which the question information belongs may be customer service. By means of this manner, the question information can be positioned to a corresponding field according to the question information, and moreover, an intention expressed by the question information can be identified precisely, so as to provide a variety of functional services for the user.

In an optional implementation, using a QA system in a game client as an example, as shown in FIG. 4, when target question information “how to open a Three Realms instance?” inputted by a player is received, filter processing is performed on the target question information to remove unimportant words such as punctuations, function words, and adverbs, to obtain a complete word sequence “how, open, Three Realms, instance”. Then, a phrase “Three Realms instance” with highest relevance to these words is obtained and queried according to hyponymy relationships between words, and these words are inputted into an interpreter of the AIML. Finally, it is determined that an intention of the player is to obtain a method for opening a Three Realms instance. The foregoing target question information is positioned to an information topic of the “Three Realms instance”, and corresponding reply information is retrieved from a knowledge base corresponding to the Three Realms instance. Information of the obtained target reply information such as “brief introduction of Three Realms instance”, “method for entering Three Realms instance”, and “mission accomplishing strategy of Three Realms instance” are displayed on the display interface of the client.

Obviously, through the foregoing apparatus, question information and reply information that correspond to each other are classified into a plurality of information groups according to information topics of the question information. When target reply information corresponding to target question information is to be obtained, a target information topic to which the target question information belongs is first determined, and then the target reply information corresponding to the target question information is obtained from a target information group corresponding to the target information topic, so that a question intention of the target question information can be positioned accurately. The target question information is positioned to the target information topic corresponding to the same intention, and the target reply information is obtained from the target information group corresponding to the target information topic, thereby avoiding querying a large quantity of QA-pairs templates, improving the efficiency of obtaining the reply information, and further resolving the technical problem of relatively low efficiency of obtaining the reply information in the related art.

In an optional solution, the second determining module includes:

(1) a first lookup unit, configured to look up an information topic to which each keyword in target keywords belongs from a plurality of information topics; and

(2) a first determining unit, configured to determine the information topic to which each keyword in the target keywords belongs as a target information topic to which target question information belongs.

Optionally, in this embodiment, the information topic corresponding to each keyword in the target keyword may be determined as the target information topic corresponding to the target question information, thereby positioning an intention expressed by the target question information.

Optionally, in this embodiment, the information topics to which the keywords in the target keyword belong may have certain relationships. In this case, the information topics to which the keywords in the target keyword belong may be combined according to these relationships. For example, if information topics to which two words belong are in a hyponymy relationship, an information topic to which a hypernym word belongs is removed through filtering, and only an information topic to which a hyponym word belongs is used as the target information topic. Alternatively, the information topic to which the hyponym word belongs may be removed through filtering, and only the information topic to which the hypernym word belongs is used as the target information topic. In this way, a range for positioning the target question information is controlled.

In an optional solution, the first obtaining module includes:

(1) a first obtaining unit, configured to obtain a target tag corresponding to the target information topic, the target tag being used for identifying the target information topic;

(2) a second obtaining unit, configured to obtain the target information group corresponding to the target tag from tags and information groups that correspond to each other;

(3) a second lookup unit, configured to look up reply information corresponding to the target question information from each information group of the target information group respectively; and

(4) a combining unit, configured to combine the reply information corresponding to the target question information in each information group into the target reply information.

Optionally, in this embodiment, corresponding tags may be allocated to the information topics to identify the information topics, and a correspondence between the tags and the information groups may be created. After the target information topic of the target question information is determined, the target information group may be obtained according to the tag corresponding to the target information topic.

Optionally, in this embodiment, the target information group may be one or more information groups. If there are a plurality of target information groups, each piece of reply information corresponding to the target question information may be obtained from each target information group, and then the pieces of reply information are combined into the target reply information.

In an optional solution, the first determining module includes:

(1) an extraction unit, configured to extract a first keyword from the target question information to obtain a word sequence including the first keyword;

(2) a third obtaining unit, configured to obtain a relationship sequence corresponding to the word sequence from a graph master, the graph master using the plurality of information topics as nodes, the graph master being used for recording hyponymy relationships between the nodes, and the relationship sequence being used for indicating a hyponymy relationship between the first keywords; and

(3) a second determining unit, configured to determine that the target keyword includes the word sequence and the relationship sequence.

Optionally, in this embodiment, the process of extracting the first keyword from the target question information may include a pre-processing process, a word segmentation process, a keyword determining process, and a word sequence generating process. The target question information is pre-processed and cleaned in the pre-processing process, so that redundancy information such as symbols and stop words is removed. The target question information is divided into words with different granularities in the word segmentation process. An appropriate word is extracted from the words with different granularities as the first keyword in the keyword determining process. In the word sequence generating process, the word sequence is generated by using the determined first keyword. For example, after a user inputs a sentence, a data pre-processing and cleaning process is performed on the sentence to remove special symbols and stop words, and a word sequence is obtained by using a probabilistic annotation model of hidden markov model (HMM)+conditional random field (CRF).

Optionally, in this embodiment, the hyponymy relationships between the plurality of information topics may be recorded by using a graph master. For example, as shown in FIG. 5, the graph master uses a plurality of information topics (an information topic A, an information topic B, an information topic C, an information topic D, an information topic E, an information topic F, and an information topic G) as nodes, and uses connection relationships between the nodes to represent hyponymy relationships between the information topics. For example, two associated information topics are connected by using an arrow, where an information topic at a start point of the arrow is a hypernym information topic of an information topic at an end of the arrow, and the information topic at the end of the arrow is a hyponym information topic of the information topic at the start point of the arrow. Hyponym information topics of the information topic A include the information topic B, the information topic C, and the information topic D; a hyponym information topic of the information topic B includes the information topic E; and hyponym information topics of the information topic C include the information topic F and the information topic G.

Optionally, in this embodiment, the tag used for identifying the information topic may be, but is not limited to, a tag in the AIML, and there is a correspondence between tags and information topics. After obtaining a first information topic to which a word sequence belongs and a second information topic to which a relationship sequence belongs, a first tag corresponding to the first information topic and a second tag corresponding to the second information topic may be obtained, and an intention expressed by target question information is precisely indicated by using the first tag and the second tag. The first tag and the second tag are added to an AIML file, and the AIML file is executed to invoke a first information group corresponding to the first tag to obtain first reply information, and invoke a second information group corresponding to the second tag to obtain second reply information. The first reply information and the second reply information are combined to obtain the target reply information.

For example, the second determining module is configured to: obtain a first information topic to which a word sequence belongs in a plurality of information topics, and obtain a second information topic to which a relationship sequence belongs in the plurality of information topics. The obtaining module is configured to: obtain a first tag corresponding to the first information topic, and obtain a second tag corresponding to the second information topic; generate an AIML file carrying the first tag and the second tag; execute the AIML file to look up a first information group corresponding to the first tag for first reply information corresponding to target question information, and to look up a second information group corresponding to the second tag for second reply information corresponding to the target question information; and combine the first reply information and the second reply information to obtain the target reply information.

Optionally, in this embodiment, the tag may be used for, but is not limited to, representing functions that can be implemented by the AIML file, for example, weather, database, joke, idiom, customer service, context, time, recursion, memory, knowledge, and other functions. For example, the weather function may be used for querying the weather, the customer service function may be used for connecting to a customer service system, and the context function may be used for analyzing a context. Other functions are similar to this, and details are not described herein again.

The foregoing functions that can be implemented by the tags in this embodiment are merely an example, other functions (for example, history, food, movie information, music, film, entertainment, game, and the like) may further be configured, which are not limited in this embodiment herein.

In an optional solution, in a case that the target reply information corresponding to the target question information is not obtained from the target information group in the plurality of information groups, the apparatus further includes:

(1) an input module, configured to input the target question information into a predetermined information group;

(2) a second obtaining module, configured to obtain a plurality of pieces of reply information corresponding to the target question information outputted by the predetermined information group; and

(3) a third obtaining module, configured to obtain reply information satisfying a target condition from the plurality of pieces of reply information, and determine the reply information satisfying the target condition as the target reply information.

Optionally, in this embodiment, if the target reply information is not hit in the target information group, the target reply information may be obtained through a deep learning model in the predetermined information group.

Optionally, in this embodiment, a plurality of pieces of reply information corresponding to the target question information may be obtained through the deep learning model, and reply information satisfying the target condition is found in the plurality of pieces of reply information to serve as the target reply information.

In an optional solution, the third obtaining module includes:

(1) a fourth obtaining unit, configured to obtain relevance between each piece of reply information in the plurality of pieces of reply information and the target question information; and

(2) a third determining unit, configured to determine a target quantity of pieces of corresponding reply information with highest relevance in the plurality of pieces of reply information as the reply information satisfying the target condition.

Optionally, in this embodiment, the plurality of pieces of reply information may be sorted according to relevance between each piece of reply information and the target question information, and several pieces of reply information with the highest relevance are used as the reply information satisfying the target condition.

Optionally, in this embodiment, a learning and updating function may further be implemented. For example, reply information selected by a user from a plurality of pieces of information satisfying the condition may be detected, and a correspondence between target question information and the reply information is created and recorded in a target information group corresponding to a target information topic to which the target question information belongs. Therefore, the reply information is used as target reply information when question information similar to the target question information is obtained next time.

In an optional solution, the apparatus further includes:

(1) a transmission module, configured to transmit the target reply information to the client to instruct the client to display the target reply information on a display interface of the client; and

(2) a display module, configured to display the target reply information on the display interface of the client.

Optionally, in this embodiment, the foregoing reply information obtaining apparatus may be disposed in a server, or may be disposed in a client. After the target reply information is obtained, the target reply information may be displayed on the client. If the target reply information is obtained by the server, the server may transmit the target reply information to the client, to instruct the client to display the target reply information on the display interface of the client, and the target reply information is displayed on the display interface by the client. If the target reply information is obtained by the client, the client may display the obtained target reply information on the display interface.

Optionally, in this embodiment, the foregoing reply information obtaining apparatus may further be disposed in a client and a server respectively. For example, the client obtains target question information, and determines a target keyword corresponding to the target question information according to the obtained target question information. The client transmits the target keyword to the server. The server determines, according to the target keyword, a target information topic to which the target question information belongs in a plurality of information topics, and obtains target reply information corresponding to the target question information from a target information group in a plurality of information groups. The server returns the target reply information to the client, and the client displays the target reply information on the display interface.

For an application environment of this embodiment of this application, reference may be made but is not limited to the application environment of the foregoing embodiment. This is not described in detail in this embodiment. This embodiment of this application provides an optional specific application example for implementing the foregoing real-time communication connection method.

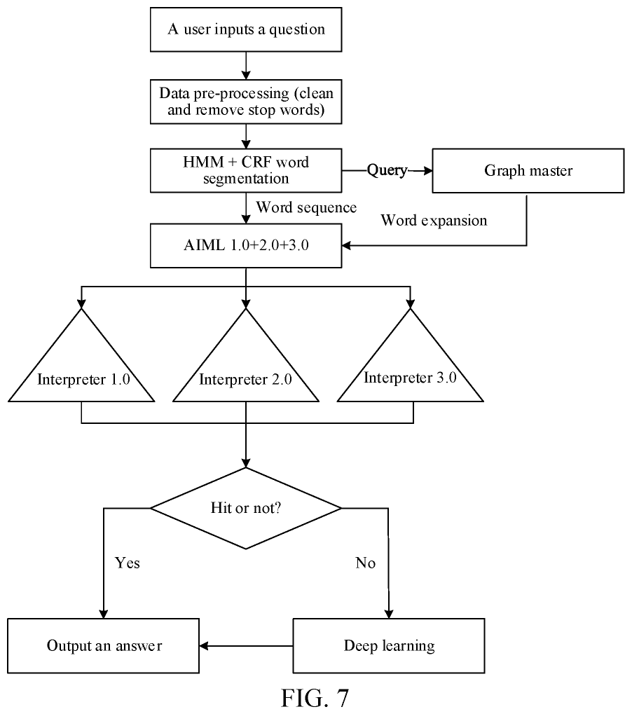

In an optional embodiment, the foregoing reply information obtaining method may be applied to, but is not limited to, a scenario of obtaining reply information corresponding to question information as shown in FIG. 7. In this scenario, an AIML module that reconstructs a rule template is used to resolve a problem that NLU recognition is difficult in a vertical field. A rule NLU parsing system provided in this scenario includes the following three modules:

(1) AIML 1.0-2.0 module: the module is formed based on four common AIML tags, <aiml><category><pattern><template> form an extensible markup language (XML-extend) text library, and the most basic regular matching is implemented by using tags. <pattern> is used as an input of a key, and <template> is used as generation of an answer template. QA-pairs in the vertical field correspond to <pattern> and <template> of the AIML respectively.

(2) AIML 3.0 module: the module is newly added with a plurality of tags, including tags such as weather, database, joke, idiom, customer service, context, time, recursion, memory, and knowledge, and is encapsulated with a graph master and a deep learning tag module, so that the AIML 3.0 has the capability to process Chinese NLU in a real sense, especially functions of memory and contextual semantic understanding, and can be applied to a smart customer service NLU system in any vertical field.

(3) Result output module: this system adopts a form of a skip list, and the complexity of inserting lookup tag data is decreased greatly a skip lookup manner. In data at the level of 100 million, an average effect of 0.12 s is achieved with a stand-alone single thread.

In this system, a problem of small sample data may be resolved by using characteristics of AIML 3.0 custom tags. As a semi-generative AIML, this solution may generate a large quantity of samples with relatively high quality by using a small quantity of accurate samples, and achieve related contextual semantic understanding by using semantic tags.

Optionally, in this scenario, the foregoing system performs Chinese word segmentation on the obtained target question information based on the HMM+CRF. After a user inputs a sentence, data pre-processing is performed on the sentence to remove stop words, and word segmentation processing is performed to obtain a series of word sequences. A corresponding AIML template may be generated by using a space vector identifier and a sentence dependency analysis tree.

Optionally, in this scenario, the AIML 3.0 module greatly expands functions of the AIML itself In this solution, a graph master is constructed. Each AIML tag corresponds to one node, and each tag is responsible for one function module, to construct an interpreter corresponding to the AIML. After obtaining a word sequence of a user, the interpreter traverses the most similar template, and returns reply information to the user.

In this scenario, the system can resolve most of the NLU problems by using fully functional tags for coverage and combination to generate a complex tag interpreter. For example, in a question answering system scenario of a mobile game, after target question information inputted by a user is obtained, a corresponding word sequence is obtained through data pre-processing. Top 3 words with the highest probability of use are calculated by using a model, and matched with corresponding tags. Corresponding reply information is returned. Then, an NLU semantic understanding problem becomes a regular retrieval problem, thereby achieving obvious effects in the vertical field scenario. In this system, the graph master is further encapsulated as a tag module. When a word sequence inputted by a user is obtained, a more accurate user intention is obtained by retrieving a corresponding graph database and triplet, thereby avoiding ambiguity to a great extent.

Optionally, in this scenario, the foregoing system further includes: a deep learning module. The module adopts a framework of seq2seq, and the NLU problems have not been resolved by the AIML 1.0-2.0 module and the AIML 3.0 module yet are left for the deep learning module to resolve. The deep learning module adopts a model framework of a convolutional neural network (CNN)+a long short-term memory (LSTM). High recognition for a Char character level is realized through a CNN model, and an NLU task is processed by using a sequence annotation model of the LSTM.

In an optional implementation, as shown in FIG. 7, after a user inputs a sentence, special symbols and stop words are removed through a data pre-processing module, and a word sequence is obtained by using the probabilistic annotation model of HMM+CRF. The graph database is queried at the same time, and a more accurate word sequence and relationship sequence are obtained according to the hyponymy relationship recorded in the graph master, and then the accurate intention of the user is obtained by using the AIML 1.0+2.0+3.0 modules. Then, an answer to be returned is retrieved from the interpreters 1.0-3.0. If a corresponding answer is not retrieved, three answers with the highest relevance are returned through the deep learning model.

The foregoing system resolves a problem that a machine learning method and a deep learning method require a large amount of data to resolve the NLU problem, and accuracy and a recall rate are improved greatly at the same time. In addition, the functions may be customized, and the system can be flexibly applied to various vertical field scenarios.

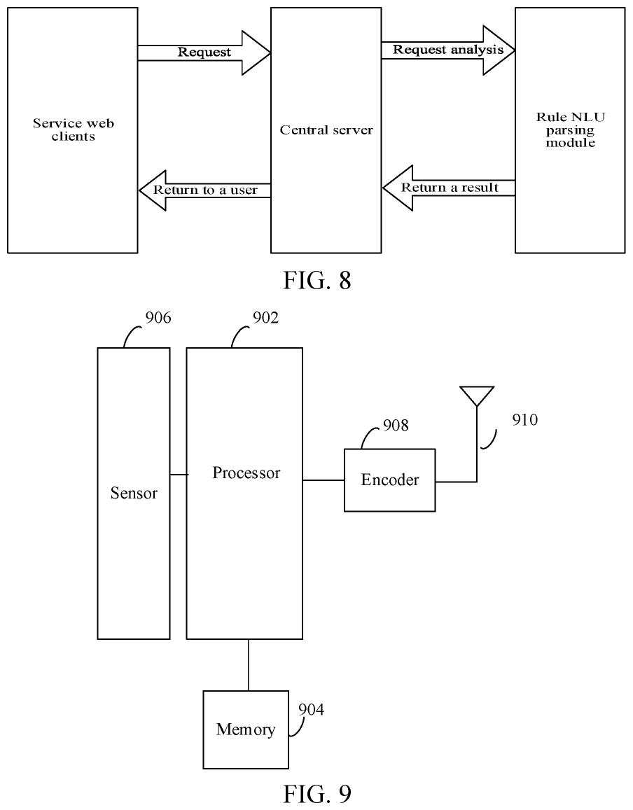

Optionally, in this embodiment, the foregoing system may be applied to a hardware scenario composed of service web clients, a central server, and a rule NLU parsing module as shown in FIG. 8, and the foregoing rule NLU parsing system is arranged in the rule NLU parsing module. Each service web client transmits a request to the central server to request reply information corresponding to target question information. The central server performs distributed scheduling, and then transmits the request to an interface provided by the rule NLU parsing module, where the request carries the target question information and a client ID. The rule NLU parsing module may be disposed in a java model-view-controller (java MVC) framework. After receiving the target question information and the client ID, the server invokes the rule NLU parsing module in the java MVC framework to obtain the target reply information. If the target reply information is not obtained, a deep learning framework model may be invoked to obtain three answers with the highest relevance as a result returned to the rule NLU parsing module. After interface processing of the rule NLU parsing module is completed, the result is returned to the central server in a form of Json. Then the central server returns the result to the client according to caching and a word filter module (which mainly filters reactionary and political words), so that the user obtains the corresponding answer.

Optionally, the procedure of the rule NLU parsing module may be deployed in a target server, and the target server may use the following configuration parameters: Intel(R) Xeon(R) CPU E5-2620 v3, 40 gigabytes of memory. The deep learning module may invoke a tensorflow detection module based on python, and configuration parameters of a server configured with the deep learning module may be Intel(R) Xeon(R) CPU E5-2620 v3, 60 gigabytes of memory, and 512 SSD.

The foregoing system resolves problems of difficult NLU recognition and low precision of the question answering system in the vertical field, and overcomes shortcomings of the machine learning and the deep learning in resolving the NLU problem. The accuracy and recall rate of the question answering system are greatly improved.

According to still another aspect of the embodiments of this application, an electronic apparatus configured to perform the obtaining the reply information is further provided. As shown in FIG. 9, the electronic apparatus includes one or more (only one is shown in the figure) processors 902, a memory 904, a sensor 906, an encoder 908, and a transmission apparatus 910. The memory stores a computer program, and the processor is configured to perform steps in any one of the foregoing method embodiments through the computer program.

Optionally, in this embodiment, the foregoing electronic apparatus may be located in at least one of a plurality of network devices of a computer network.

Optionally, in this embodiment, the foregoing processor may be configured to perform the following steps through a computer program:

S1. Determine a target keyword corresponding to target question information according to the target question information obtained by a client.

S2. Determine, according to the target keyword, a target information topic to which the target question information belongs in a plurality of information topics.

S3. Obtain target reply information corresponding to the target question information from a target information group in a plurality of information groups, the target information group including a plurality of pairs of question information and reply information that correspond to each other, and the question information included in the target information group belonging to the target information topic.

A person of ordinary skill in the art may understand that, the structure shown in FIG. 9 is only illustrative. The electronic apparatus may be a terminal device such as a smartphone (for example, an Android mobile phone or an iOS mobile phone), a tablet computer, a palmtop computer, a mobile Internet device (MID), or a portable Android device (PAD). FIG. 9 does not constitute a limitation on a structure of the foregoing electronic apparatus. For example, the electronic apparatus may further include more or fewer components (such as a network interface and a display apparatus) than those shown in FIG. 9, or have a configuration different from that shown in FIG. 9.

The memory 902 may be configured to store a software program and a module, for example, program instructions/modules corresponding to the reply information obtaining method and apparatus in the embodiments of this application. The processor 904 runs the software program and module stored in the memory 902, to implement various functional applications and data processing, that is, implement the foregoing method for controlling the target assembly. The memory 902 may include a high-speed random memory, and may further include a non-volatile memory such as one or more magnetic storage apparatuses, a flash memory, or another non-volatile solid-state memory. In some examples, the memory 902 may further include memories remotely disposed relative to the processor 904, and these remote memories may be connected to a terminal through a network. Instances of the network include, but are not limited to, the Internet, an intranet, a local area network, a mobile communications network, and a combination thereof.

The transmission apparatus 910 is configured to receive or transmit data by using a network. Instances of the foregoing network may include a wired network and a wireless network. In an example, the transmission apparatus 910 includes a network interface controller (NIC), which may be connected to another network device and a router by using a cable, to communicate with the Internet or a local area network. In an example, the transmission apparatus 910 is a radio frequency (RF) module, which is configured to communicate with the Internet in a wireless manner.

Optionally, the memory 902 is configured to store an application program.

According to the embodiments of this application, a storage medium is further provided. The storage medium stores a computer program, the computer program being configured to perform steps in any one of the foregoing method embodiments when being run.

Optionally, in this embodiment, the storage medium may be configured to store a computer program used for performing the following steps:

S1. Determine a target keyword corresponding to target question information according to the target question information obtained by a client.

S2. Determine, according to the target keyword, a target information topic to which the target question information belongs in a plurality of information topics.

S3. Obtain target reply information corresponding to the target question information from a target information group in a plurality of information groups, the target information group including a plurality of pairs of question information and reply information that correspond to each other, and the question information included in the target information group belonging to the target information topic.

Optionally, the storage medium is further configured to store a computer program configured to perform steps included in the method in the foregoing embodiments, and details are not described again in this embodiment.

Optionally, in this embodiment, a person of ordinary skill in the art may understand that all or some of the steps of the methods in the foregoing embodiments may be implemented by a program instructing relevant hardware of a terminal device. The program may be stored in a computer-readable storage medium. The storage medium may include a flash disk, a read-only memory (ROM), a random access memory (RAM), a magnetic disk, an optical disc, and the like.

The sequence numbers of the foregoing embodiments of this application are merely for description purpose, and do not indicate the preference among the embodiments.

When the integrated unit in the foregoing embodiments is implemented in a form of a software functional unit and sold or used as an independent product, the integrated unit may be stored in the foregoing computer-readable storage medium. Based on such understanding, the technical solutions of this application essentially, or the part contributing to the related art, or all or some of the technical solutions may be implemented in a form of a software product. The computer software product is stored in a storage medium and includes several instructions for instructing one or more computer devices (which may be a personal computer, a server, a network device, or the like) to perform all or some of steps of the methods in the embodiments of this application.

In the foregoing embodiments of this application, descriptions of the embodiments have different emphases, and as for parts that are not described in detail in one embodiment, reference can be made to the relevant descriptions of the other embodiments.

In the several embodiments provided in this application, it is understood that the disclosed client may be implemented in other manners. For example, the described apparatus embodiment is merely an example. For example, the unit division is merely logical function division and may be another division in an actual implementation. For example, a plurality of units or components may be combined or integrated into another system, or some features may be ignored or not performed. In addition, the coupling, or direct coupling, or communication connection between the displayed or discussed components may be the indirect coupling or communication connection by means of some interfaces, units, or modules, and may be in electrical or other forms.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions in the embodiments.

In addition, functional units in the embodiments of this application may be integrated into one processing unit, or each of the units may exist alone physically, or two or more units are integrated into one unit. The integrated unit may be implemented in the form of hardware, or may be implemented in the form of software functional unit.

The foregoing descriptions are merely exemplary implementations of this application. A person of ordinary skill in the art may make improvements and modifications without departing from the principle of this application, and all such improvements and modifications fall within the protection scope of this application.

What is claimed is:

1. A r method of obtaining reply information performed by a computing device having one or more processors and memory storing a plurality of programs to be executed by the one or more processors, the method comprising:
determining, by the computing device, a target keyword corresponding to target question information obtained by a client;
determining, by the computing device according to the target keyword, a target information topic to which the target question information belongs among a plurality of information topics; and
obtaining, by the computing device, target reply information corresponding to the target question information from a target information group among a plurality of information groups, the target information group comprising a plurality of pairs of question information and reply information that correspond to each other, and the question information in the target information group belonging to the target information topic.

2. The method according to claim 1, wherein the determining, by the computing device according to the target keyword, a target information topic to which the target question information belongs in a plurality of information topics comprises:
looking up, by the computing device, an information topic to which each keyword in the target keyword belongs from the plurality of information topics; and
determining, by the computing device, the information topic to which each keyword in the target keyword belongs as the target information topic to which the target question information belongs.

3. The method according to claim 1, wherein the obtaining, by the computing device, target reply information corresponding to the target question information from a target information group among a plurality of information groups comprises:
obtaining, by the computing device, a target tag corresponding to the target information topic, the target tag being used for identifying the target information topic;
obtaining, by the computing device, the target information group corresponding to the target tag from tags and information groups that correspond to each other;
looking up, by the computing device, reply information corresponding to the target question information from each information group of the target information group respectively; and
combining, by the computing device, the reply information corresponding to the target question information in each information group into the target reply information.

4. The method according to claim 1, wherein the determining, by the computing device, a target keyword corresponding to target question information obtained by a client comprises:
extracting, by the computing device, a first keyword from the target question information to obtain a word sequence comprising the first keyword;
obtaining, by the computing device, a relationship sequence corresponding to the word sequence from a graph master, the graph master using the plurality of information topics as nodes, the graph master being used for recording hyponymy relationships between the nodes, and the relationship sequence being used for indicating a hyponymy relationship between the first keywords; and
determining, by the computing device, that the target keyword comprises the word sequence and the relationship sequence.

5. The method according to claim 4, wherein
the determining, by the computing device according to the target keyword, a target information topic to which the target question information belongs in a plurality of information topics comprises: obtaining, by the computing device, a first information topic to which the word sequence belongs in the plurality of information topics, and obtaining a second information topic to which the relationship sequence belongs in the plurality of information topics; and
the obtaining, by the computing device, target reply information corresponding to the target question information from a target information group in a plurality of information groups comprises:
obtaining, by the computing device, a first tag corresponding to the first information topic, and obtaining a second tag corresponding to the second information topic;
generating, by the computing device, an artificial intelligence markup language (AIML) file carrying the first tag and the second tag;
executing, by the computing device, the AIML file to look up a first information group corresponding to the first tag for first reply information corresponding to the target question information, and to look up a second information group corresponding to the second tag for second reply information corresponding to the target question information; and
combining, by the computing device, the first reply information and the second reply information to obtain the target reply information.

6. The method according to claim 1, wherein in a case that the computing device does not obtain the target reply information corresponding to the target question information from the target information group in the plurality of information groups, the method further comprises:
inputting, by the computing device, the target question information into a predetermined information group;
obtaining, by the computing device, a plurality of pieces of reply information corresponding to the target question information outputted by the predetermined information group; and
obtaining, by the computing device, reply information satisfying a target condition from the plurality of pieces of reply information, and determining the reply information satisfying the target condition as the target reply information.

7. The method according to claim 6, wherein the obtaining, by the computing device, reply information satisfying a target condition from the plurality of pieces of reply information comprises:
obtaining, by the computing device, relevance between each piece of reply information in the plurality of pieces of reply information and the target question information; and
determining, by the computing device, a target quantity of pieces of corresponding reply information with highest relevance in the plurality of pieces of reply information as the reply information satisfying the target condition.

8. The method according to claim 1, further comprising:
after obtaining, by the computing device, target reply information corresponding to the target question information from a target information group in a plurality of information groups,
transmitting, by the computing device, the target reply information to the client to instruct the client to display the target reply information on a display interface of the client; or
causing, by the computing device, display of the target reply information on the display interface of the client.

9. A computing device, comprising a processor and a memory, the memory storing at least one instruction, at least one program, a code set, or an instruction set, the at least one instruction, the at least one program, the code set, or the instruction set being loaded and executed by the processor to implement a method of obtaining reply information by performing a plurality of operations including:
determining, by the computing device, a target keyword corresponding to target question information obtained by a client;
determining, by the computing device according to the target keyword, a target information topic to which the target question information belongs among a plurality of information topics; and
obtaining, by the computing device, target reply information corresponding to the target question information from a target information group among a plurality of information groups, the target information group comprising a plurality of pairs of question information and reply information that correspond to each other, and the question information in the target information group belonging to the target information topic.

10. The computing device according to claim 9, wherein the determining, by the computing device according to the target keyword, a target information topic to which the target question information belongs in a plurality of information topics comprises:
looking up, by the computing device, an information topic to which each keyword in the target keyword belongs from the plurality of information topics; and
determining, by the computing device, the information topic to which each keyword in the target keyword belongs as the target information topic to which the target question information belongs.

11. The computing device according to claim 9, wherein the obtaining, by the computing device, target reply information corresponding to the target question information from a target information group among a plurality of information groups comprises:
obtaining, by the computing device, a target tag corresponding to the target information topic, the target tag being used for identifying the target information topic;
obtaining, by the computing device, the target information group corresponding to the target tag from tags and information groups that correspond to each other;
looking up, by the computing device, reply information corresponding to the target question information from each information group of the target information group respectively; and
combining, by the computing device, the reply information corresponding to the target question information in each information group into the target reply information.

12. The computing device according to claim 9, wherein the determining, by the computing device, a target keyword corresponding to target question information obtained by a client comprises:
extracting, by the computing device, a first keyword from the target question information to obtain a word sequence comprising the first keyword;
obtaining, by the computing device, a relationship sequence corresponding to the word sequence from a graph master, the graph master using the plurality of information topics as nodes, the graph master being used for recording hyponymy relationships between the nodes, and the relationship sequence being used for indicating a hyponymy relationship between the first keywords; and
determining, by the computing device, that the target keyword comprises the word sequence and the relationship sequence.

13. The computing device according to claim 12, wherein
the determining, by the computing device according to the target keyword, a target information topic to which the target question information belongs in a plurality of information topics comprises: obtaining, by the computing device, a first information topic to which the word sequence belongs in the plurality of information topics, and obtaining a second information topic to which the relationship sequence belongs in the plurality of information topics; and
the obtaining, by the computing device, target reply information corresponding to the target question information from a target information group in a plurality of information groups comprises:
obtaining, by the computing device, a first tag corresponding to the first information topic, and obtaining a second tag corresponding to the second information topic;
generating, by the computing device, an artificial intelligence markup language (AIML) file carrying the first tag and the second tag;
executing, by the computing device, the AIML file to look up a first information group corresponding to the first tag for first reply information corresponding to the target question information, and to look up a second information group corresponding to the second tag for second reply information corresponding to the target question information; and
combining, by the computing device, the first reply information and the second reply information to obtain the target reply information.

14. The computing device according to claim 9, wherein in a case that the computing device does not obtain the target reply information corresponding to the target question information from the target information group in the plurality of information groups, the method further comprises:
inputting, by the computing device, the target question information into a predetermined information group;
obtaining, by the computing device, a plurality of pieces of reply information corresponding to the target question information outputted by the predetermined information group; and
obtaining, by the computing device, reply information satisfying a target condition from the plurality of pieces of reply information, and determining the reply information satisfying the target condition as the target reply information.

15. The computing device according to claim 14, wherein the obtaining, by the computing device, reply information satisfying a target condition from the plurality of pieces of reply information comprises:
obtaining, by the computing device, relevance between each piece of reply information in the plurality of pieces of reply information and the target question information; and
determining, by the computing device, a target quantity of pieces of corresponding reply information with highest relevance in the plurality of pieces of reply information as the reply information satisfying the target condition.

16. The computing device according to claim 9, wherein the plurality of operations further comprise:
after obtaining, by the computing device, target reply information corresponding to the target question information from a target information group in a plurality of information groups,
transmitting, by the computing device, the target reply information to the client to instruct the client to display the target reply information on a display interface of the client; or
causing, by the computing device, display of the target reply information on the display interface of the client.

17. A non-transitory computer-readable storage medium, storing at least one instruction, at least one program, a code set, or an instruction set, the at least one instruction, the at least one program, the code set, or the instruction set being loaded and executed by a processor of a computing device to implement a method of obtaining reply information by performing a plurality of operations including:
determining, by the computing device, a target keyword corresponding to target question information obtained by a client;
determining, by the computing device according to the target keyword, a target information topic to which the target question information belongs among a plurality of information topics; and
obtaining, by the computing device, target reply information corresponding to the target question information from a target information group among a plurality of information groups, the target information group comprising a plurality of pairs of question information and reply information that correspond to each other, and the question information in the target information group belonging to the target information topic.

18. The non-transitory computer-readable storage medium according to claim 17, wherein the determining, by the computing device according to the target keyword, a target information topic to which the target question information belongs in a plurality of information topics comprises:
looking up, by the computing device, an information topic to which each keyword in the target keyword belongs from the plurality of information topics; and
determining, by the computing device, the information topic to which each keyword in the target keyword belongs as the target information topic to which the target question information belongs.

19. The non-transitory computer-readable storage medium according to claim 17, wherein the obtaining, by the computing device, target reply information corresponding to the target question information from a target information group among a plurality of information groups comprises:
obtaining, by the computing device, a target tag corresponding to the target information topic, the target tag being used for identifying the target information topic;
obtaining, by the computing device, the target information group corresponding to the target tag from tags and information groups that correspond to each other;
looking up, by the computing device, reply information corresponding to the target question information from each information group of the target information group respectively; and
combining, by the computing device, the reply information corresponding to the target question information in each information group into the target reply information.

20. The non-transitory computer-readable storage medium according to claim 17, wherein the determining, by the computing device, a target keyword corresponding to target question information obtained by a client comprises:
extracting, by the computing device, a first keyword from the target question information to obtain a word sequence comprising the first keyword;
obtaining, by the computing device, a relationship sequence corresponding to the word sequence from a graph master, the graph master using the plurality of information topics as nodes, the graph master being used for recording hyponymy relationships between the nodes, and the relationship sequence being used for indicating a hyponymy relationship between the first keywords; and
determining, by the computing device, that the target keyword comprises the word sequence and the relationship sequence.
